(19) United States
(12) Patent Application Publication
(10) Pub. No.: US 2006/0282025 A1
(43) Pub. Date: Dec. 14, 2006

(54) Portable vibration device

(76) Inventors: Gerald Andrew McDonald, ST. Pete Beach, FL (US); Robert B. Fuhrer, Chappaqua, NY (US); Nobuaki Ogihara, Kita-ku, Tokyo (JP)

Correspondence Address: DINESH AGARWAL, P.C., 5350 SHAWNEE ROAD, SUITE 330, ALEXANDRIA, VA, 22312, US

(21) Appl. No.: 10/569,598

(22) PCT Filed: Sep. 10, 2004
(86) PCT No.: PCT/US04/26731

§ 371 Date: Feb. 24, 2006

Related U.S. Application Data
(60) Provisional application No. 60/502,517, filed on Sep. 12, 2003.

(51) Int. Cl. A61H 1/00

(52) U.S. Cl. 601/46

(57) ABSTRACT

A portable vibration device (PVD) for attaching to a structure or person, includes a vibration-producing component (VC), and a clamping component (CC) for attaching the vibration-producing component (VC) to a structure or person to transmit vibrations thereto. The clamping component (CC) is slidable relative to the vibration-producing component (VC) for adjusting a distance between the vibration-producing component (VC) and a structure or person. One of the vibration-producing component (VC) and the clamping component (CC) includes a recess for storing the other of the vibration-producing component (VC) and the clamping component (CC) when the vibration device is not in use thereby providing a compact unit. The device includes various attachments for different applications.

### CROSS-REFERENCE TO RELATED APPLICATIONS

The present invention claims priority on prior U.S. Provisional Application Ser. No. 60/502,517, filed Sep. 12, 2003, which is hereby incorporated herein in its entirety by reference.

### BACKGROUND OF THE INVENTION

The present invention is generally directed to vibration devices, and more particularly to a portable vibration device which can be easily attached to a structure, such as a piece of furniture, or person to transmit or impart vibrations thereto.

The prior art is replete with various vibration or therapeutic devices. However, the conventional devices are complex, often difficult to attach and detach, not portable, and not versatile in that they cannot be easily attached to different types of structures. Further, they do not offer the flexibility of switching between structures and persons. Often, they are designed for one specific application rendering them useless for another application. For instance, a bed vibrating device cannot be used as a neck vibrating device and vice-versa.

Examples of conventional devices are disclosed in U.S. Patent/Patent Application Publication No. Des. 207,142; Des. 207,287; Des. 342,320; Des. 345,425; 221,752; 389,938; U.S. Pat. Nos. 2,587,207; 2,668,302; 2,920,619; 3,261,033; 3,311,935; 3,361,130; 3,455,296; 3,584,249; 3,955,222; 4,641,345; 4,681,096; 4,785,797; 4,893,366; 5,003,651; 5,106,159; 5,188,095; 5,374,238; 5,660,597; 5,776,085; 6,010,192; 6,015,394; 6,346,088; 6,648,416; 6,669,291; 2002/0091340; 2002/0095103; 2002/0096929; and 2004/0127822.

In view of the drawbacks associated with conventional devices, there is a need in the industry for a portable vibration device which is versatile in that it can be attached a wide range of structures, such as beds, chairs, baby cribs, lawn furniture, and which can be attached to containers for the agitation of liquids, solids or the materials. In addition, the device can be used to attach to a person for therapy, relaxation, etc.

### OBJECTS AND SUMMARY OF THE INVENTION

The principal object of the present invention is to provide a portable vibration device which overcomes the drawbacks associated with conventional devices.

An object of the present invention is to provide a portable vibration device which can be easily attached to, and detached from, a structure or person for transmitting or imparting vibrations thereto.

Another object of the present invention is to provide a portable vibration device which is versatile in that it can be attached to a wide variety of structures, as well as persons, to transmit vibrations thereto.

Yet another object of the present invention is to provide a portable vibration device which can be easily attached to a wide variety of objects, such as the tops of overstuffed chairs, bed headboards, cribs, baby carriages, airplane seats, automobile seats, lawn furniture, table tops, straight-back wooden chairs, bed frames/rails, plywood and metal desk chairs, platform beds, etc.

Yet another object of the present invention is to provide a portable vibration device which can be used for the agitation of liquids, solids, or other materials.

Still yet another object of the present invention is to provide a portable vibration device which transfers the maximum energy generated by the vibration mechanism to an object which comes in contact, and/or to sentient beings, liquids, solids, particulates, etc.

An additional object of the present invention is to provide a portable vibration device which is foldable for compact storage when not in use or for transport, and has a variety of switches to control the speed and intensity of the vibrations. The device optionally includes a slip-resistant material on the jaw member and/or the back of the vibration-producing unit or component and, in combination with the adjustable clamp structure, can transfer enhanced vibrations to a wide range of objects for comfort, enjoyment and healing of sentient beings. Further, the device can function as a portable unit for commercial applications, such as in medical treatment, vibration of a sieve to sort various-size objects, agitation of solutions to mix liquids and/or solids, and agitation for dissolving particulates or other material, etc.

Yet an additional object of the present invention is to provide a portable vibration device which includes various attachments to convert the device from, for example, a neck massager to a hand-held body massager. By using one or more attachments, the device can be switched for mounting to, for example, a bed frame from a chair. Likewise, the vibration-producing component of the invention can be attached to a pad to convert the device to a foot massager.

In summary, the main object of the present invention is to provide a portable vibration device, which can be easily attached to, and detached from, a wide variety of structures and objects, or persons for transmitting vibrations thereto. The device is simple in design and includes various attachments for different applications.

One of the above objects is met, in part, by the present invention which in one aspect includes a portable vibration device for attaching to a structure or person, including a vibration-producing component, and a clamping component for attaching the vibration-producing component to a structure or person to transmit vibrations thereto. The clamping component is slidable relative to the vibration-producing component for adjusting a distance between the vibration-producing component and a structure or person. One of the vibration-producing component and the clamping component includes a recess for storing the other of the vibration-producing component and the clamping component when the vibration device is not in use thereby providing a compact unit.

Another aspect of the present invention includes a portable vibration device for attaching to a structure or person, which includes a vibration-producing component with a first recess, and a clamping component for attaching the vibration-producing component to a structure or person to thereby transmit vibrations thereto. The clamping component includes an arm slidable in the first recess relative to the vibration-producing component for adjusting a distance between the vibration-producing component and a structure or person when the vibration device is in use. The vibration-producing component includes a second recess for storing the arm when the vibration is not in use thereby providing a compact unit.

Another aspect of the present invention includes a portable vibration device, which includes a vibration-producing component with a recess, an attachment component including an arm slidable in the recess, and a locking lever for locking the arm relative to the vibration-producing component. The arm includes first and second end portions. The first end portion of the arm extends into the recess.

Another aspect of the present invention includes a portable vibration device for attaching to a bed frame, which includes a vibration-producing component with a recess, and an attachment component including a first portion slidable in the recess and a second portion to be attached to a section of a bed frame. A locking member is provided for interlocking the attachment component with the section of the bed frame.

Another aspect of the present invention includes a portable vibration device for attaching to a pad, which includes a vibration-producing component with a recess, an attachment component including an arm slidable in the recess, and a locking lever for locking the arm relative to the vibration-producing component. The arm includes first and second end portions. The first end portion extends into the recess and the second end portion is attached to a pad. The vibration device can be used as a foot massager by placing at least one foot on the pad.

Another aspect of the present invention includes a portable agitator for attaching to a container, which includes a vibration-producing component with a recess, and an attachment component including a first portion slidable in the recess and a second portion for engaging a container. A locking member is provided for interlocking the attachment component with the vibration-producing component. The vibration device can be used to transmit vibrations to the container thereby agitating the material therein.

### BRIEF DESCRIPTION OF THE DRAWINGS

One of the above and other objects, novel features and advantages of the present invention will become apparent from the following detailed description of the preferred embodiment(s) of the invention, as illustrated in the drawings, in which:

FIG. 1 is a front perspective view of a portable vibration device in accordance with the present invention, shown in a use or open position;

FIG. 2 is a rear perspective view of the portable vibration device of FIG. 1, shown in a storage position;

FIG. 3 is an enlarged cross-sectional view taken along line 3-3 of FIG. 1, showing mounted on a structure illustrated in phantom lines;

FIG. 4 is rear exploded view of the vibration device shown in FIG. 1;

FIG. 5 is an alternative embodiment of the clamping component;

FIG. 6 illustrates an attachment for mounting the vibration device of the present invention to a bed frame;

FIG. 7 illustrates an attachment for using the vibration device of the present invention as a hand-held vibrator or massager;

FIG. 8 is a U-shaped attachment for using the vibration device of the present invention as a neck massager; and

FIG. 9 illustrates a pad for using the vibration device of the present invention as a foot massager.

### DETAILED DESCRIPTION OF THE PREFERRED EMBODIMENT(S) OF THE INVENTION

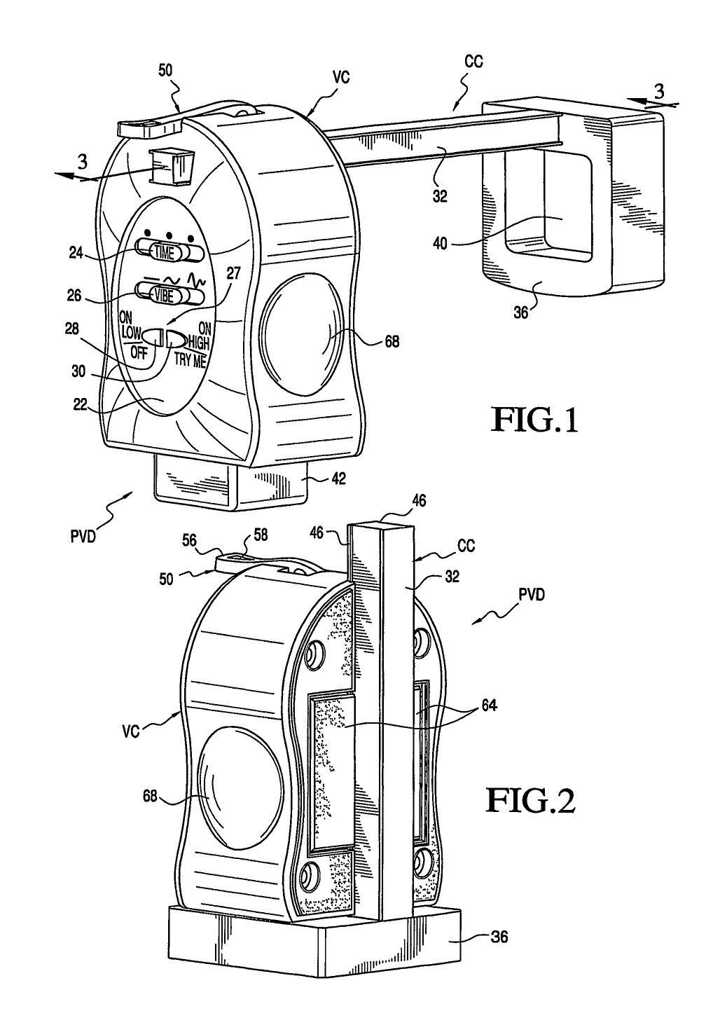

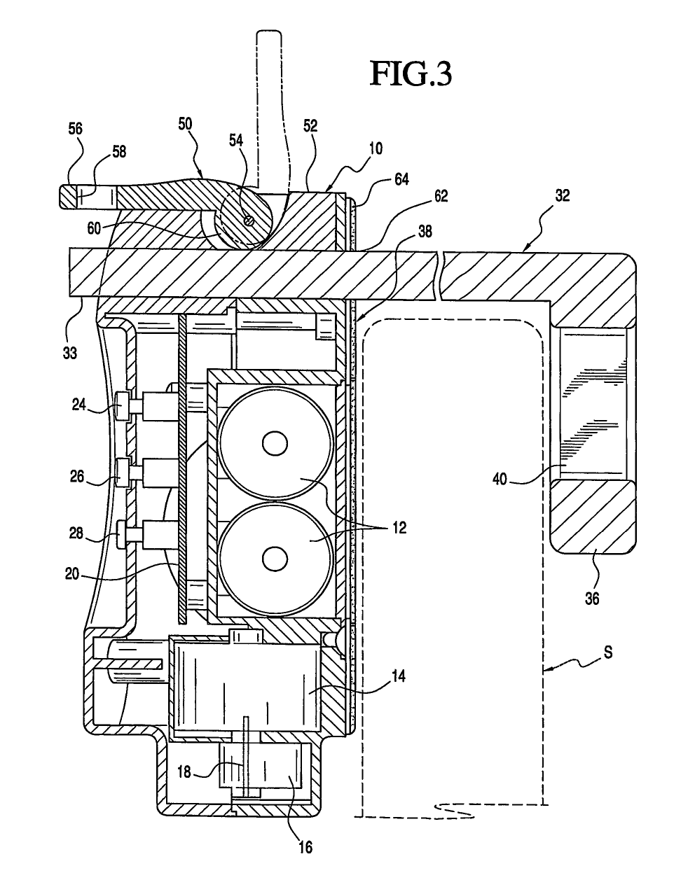

As best shown in FIGS. 1 and 4, the portable vibration device PVD of the present invention, includes a vibration-producing component VC and a clamping component CC. As best shown in FIG. 3, the vibration-producing component VC includes a housing 10 for accommodating preferably two batteries 12 that may be rechargeable, a motor 14, an eccentric weight 16 connected to the motor 14 by an output shaft 18, and a circuit board 20. (It is noted herewith that other means for producing the vibrations may alternatively be provided.) The circuit board 20 has mounted thereon various electronic components corresponding to various operational preferences available to a user, described below in more detail.

As best shown in FIG. 1, the portable vibration device PVD includes an elastomeric pressure-activated switch pad 22 with various controls. Preferably, three-position sliders 24 and 26 are provided selecting the running time and vibration settings. By actuating the slider 24, a user can select to run the device PVD for a fixed duration, such as 15 seconds, 30 seconds, one-minute, etc. Likewise, the slider 26 offers the user with steady, wave, and random settings for vibration cycles. The bottom elastomer 27 includes left and right pads 28 and 30. The left pad 28 functions as an ON/OFF switch and turns the device ON in a low-speed mode. On the other hand, the right pad 30 turns the device ON in a high-speed mode and functions as a “TRY ME” button for retail until the left pad 28 is pushed. It is noted herewith that the foregoing is provided as a preferred illustration, and other switches and/or settings may be provided to offer a user with a different selection of settings for running the portable vibration device PVD of the present invention.

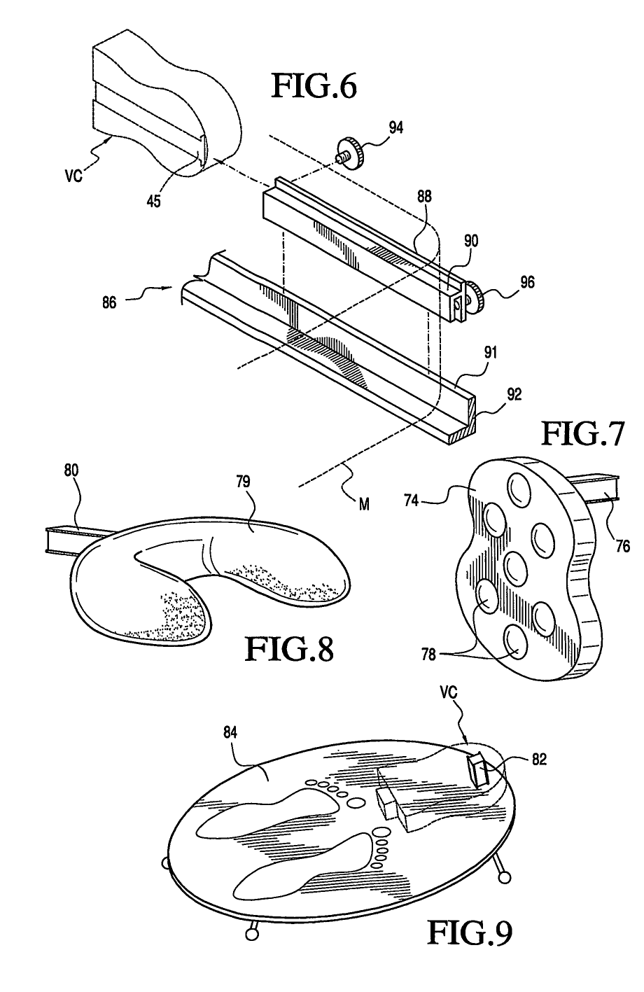

As best shown in FIGS. 1 and 4, the clamping component CC includes a generally elongated and preferably I-beam type of arm 32, the free end 33 of which extends through a recess 34 in the housing 10. The other end 35 of the arm 32 includes a preferably square-shaped jaw member 36 that extends generally transversely to the arm 32 and generally parallel to the rear 38 of the housing 10. The jaw member 36 includes an opening or recess 40 that corresponds in shape and configuration to a tab 42 provided on the bottom 44 of the housing 10. As best shown in FIGS. 2 and 4, when the portable vibration device PVD is not being used, the arm 32 may be withdrawn from the recess 34 and stored on the rear of the housing 10 by sliding the end 33 thereof up into a reentrant channel or recess 45 until the tab 42 is firmly received in the recess 40 of the jaw member 36. It is noted herewith that the flanges 46 of the arm 32 would be received in the reentrant section 48 of the channel 45, thereby locking or securing the arm 32 in place. In this manner, the clamping component CC is easily stored on the vibration-producing component VC to provide a compact portable vibration device PVD. It is noted herewith that the channel 45 may also be used for clamping the vibration-producing component VC to a structure (see FIG. 6).

In order to lock the arm 32 in the recess 34, a locking lever 50 is pivotally mounted on the top 52 of the housing 10 by a pin 54 (FIG. 3). The lever 50 includes a handle portion 56 with a finger-hole 58, and an eccentric cam portion 60. In the down position of the lever 50 (shown by solid lines in FIG. 3), the cam portion 60 engages any selected location on the top surface 62 of the arm 32 thereby locking it in place relative to the housing 10. In order to unlock the arm 32, the locking lever 50 is pivoted upwardly such that the cam portion 60 no longer engages the top surface 62, thereby allowing the arm 32 to slide in or out of the recess 34 (shown by phantom lines in FIG. 3). (It is noted herewith that other means for locking the arm 32 in the recess 34 may alternatively be provided. For example, a screw-tightening mechanism.)

As best shown in FIGS. 2-4, the rear 38 of the housing 10 is optionally provided with resilient friction-pads 64, preferably made of a high-density foam, to tightly clamp and protect a structure S, such as the back of a chair, between the vibration-producing component VC and the jaw member 36 (FIG. 3). The housing 10 may further be provided with slip-resistant gripping-pads 68 on the left and right sides thereof (only the right one is shown in the figures).

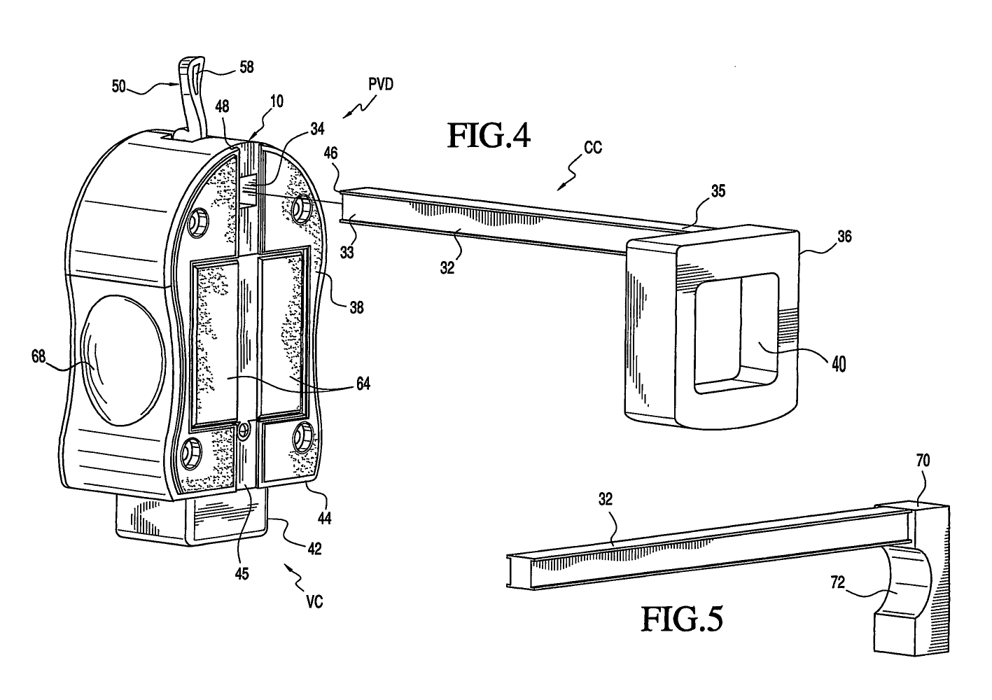

FIG. 5 illustrates an alternative embodiment of the clamping component CC, wherein a jaw member 70 is preferably in the form of a generally rectangular block with a C-shaped cutout 72. This embodiment is particularly useful for clamping the vibration device PVD to a curved or tubular section of a structure, such as a lawn chair or the like.

FIGS. 6-9 illustrate example of various attachments for use with the vibration-producing component VC of the present invention. (It is noted herewith that it is within the scope of this invention to provide other attachments.)

In particular, FIG. 7 illustrates a plate 74 contoured to fit in the hand of a user and includes a preferably I-beam type of arm 76 to be received in the recess 34 of the housing 10. The plate 74 includes massaging nodules 78. By attaching the plate 74 to the vibration-producing component VC, the vibration device PVD can be converted to a hand-held body massager.

FIG. 8 illustrates a generally U-shaped cushion 79 with a preferably I-beam type of arm 80 to be slidably received in the recess 34 of the housing 10. The cushion 79 is contoured to fit around the neck of a user and includes an internal, preferably rigid, frame (not shown) connected to the arm 80. By attaching the cushion 79 to the vibration-producing component VC, the vibration device PVD can be converted to a neck massager.

FIG. 9 illustrates the vibration-producing component VC attached to a preferably I-beam type of arm 82 mounted on a pad 84. This construction allows the vibration device PVD to be used as a foot massager.

FIG. 6 illustrates the mounting of the vibration-producing component VC to a bed frame 86. As shown, a slider plate 88 includes a generally L-shaped side plate 90 to be mounted over a vertical wall 91 of an L-beam 92 of the bed frame 86. Preferably, two screw-fasteners 94 and 96 clamp the slider plate 88 to the L-beam 92 at any location along the length thereof. In order to mount the vibration-producing component VC to the bed frame 86, one of the screw-fasteners 94 and 96 is removed and the slider plate 88 is slid into the rear channel 45. The side plate 90 is then positioned between the vertical wall 91 of L-beam 92 and the bedding or mattress M and the screw-fasteners 94 and 96 are tightened.

In order to use the portable vibration device PVD of the present invention, shown in the storage position in FIG. 2, a user simply slides down the clamping component CC until the arm 32 is completely out of the channel 45. The user than flips-up the locking lever 50 and slides the free end 33 of the arm 32 into the recess 34 and places the vibration device PVD over a portion of the structure S on which the device is to be mounted. The arm 32 is then slid into the recess 34 until the structure S is clamped between the jaw member 36 and the rear 38 of the housing 10 (FIG. 3). The user then simply flips down the locking lever 50 thereby locking the arm 32 in place. The portable vibration device PVD may then be turned on by actuating the switch 28 to transmit the vibrations produced by the eccentric weight 16 to the structure S.

From the above, one can observe that the portable vibration device PVD of the present invention can be easily used to attach to a variety of structures or to a person to transmit vibrations thereto. Further, the attachments can be used to easily reconfigure or convert the device for different applications.

While this invention has been described as having preferred sequences, ranges, steps, materials, structures, components, features, and/or designs, it is understood that it is capable of further modifications, uses and/or adaptations of the invention following in general the principle of the invention, and including such departures from the present disclosure as those come within the known or customary practice in the art to which the invention pertains, and as may be applied to the central features hereinbeforesetforth and fall within the scope of the invention and of the limits of the appended claims.

What is claimed is:

1. A portable vibration device for attaching to a structure or person, comprising:
a) a vibration-producing component;
b) a clamping component for attaching said vibration-producing component to a structure or person to transmit vibrations thereto;
c) said clamping component being slidable relative to said vibration-producing component for adjusting a distance between said vibration-producing component and a structure or person; and
d) one of said vibration-producing component and said clamping component including a first recess for storing the other of said vibration-producing component and said clamping component when the vibration device is not in use thereby providing a compact unit.

2. The device of claim 1, wherein:
a) said vibration-producing component includes said first recess for storing said clamping component.

3. The device of claim 2, wherein:
a) said vibration-producing component includes a second recess; and
b) said clamping component includes an arm to be slidably positioned in said second recess during use of the vibration device.

4. The device of claim 3, further comprising:
a) a locking member for interlocking said arm and said vibration-producing component.

5. The device of claim 4, wherein:
a) said locking member comprises a cam lever;
b) one of said vibration-producing component and said arm comprises said cam lever; and
c) said cam lever is actuable between locked and unlocked positions.

6. The device of claim 5, wherein:
a) said vibration-producing component comprises said cam lever;
b) said cam lever comprises a locking cam; and
c) said locking cam extends into second recess to lockingly engage said arm.

7. The device of claim 3, wherein:
a) said first and second recesses extend along generally orthogonal axes.

8. The device of claim 3, wherein:
a) said second recess extends through the thickness of said vibration-producing component.

9. The device of claim 3, wherein:
a) said clamping component includes a jaw member for securing the vibration device to a structure or person.

10. The device of claim 9, further comprising:
a) first and second locking members for interlocking said jaw member and said vibration-producing component when the vibration device is not in use.

11. The device of claim 10, wherein:
a) said first and second locking members comprise a tab and a third recess, respectively.

12. The device of claim 11, wherein:
a) said jaw member includes said third recess and said vibration-producing component includes said tab.

13. The device of claim 12, wherein:
a) said tab is positioned generally opposite to said second recess on said vibration-producing component.

14. The device of claim 13, wherein:
a) said vibration-producing component includes front, rear, top, and bottom;
b) said first recess extends generally vertically on the rear of said vibration-producing component and said tab is positioned about the bottom thereof; and
c) wherein said arm can be positioned in said first recess and said tab received in said third recess when the vibration device is not in use.

15. The device of claim 13, wherein:
a) said vibration-producing component includes front, rear, top, and bottom;
b) said second recess extends about the top of said vibration-producing component between front and rear thereof; and
c) wherein said arm can be positioned in said second recess and said jaw member extends generally transversely to said arm when the vibration device is in use.

16. The device of claim 9, wherein:
a) said jaw member includes a cut-out for securing to a piece of furniture.

17. The device of claim 16, wherein:
a) the cut-out is generally semi-circular in configuration for securing to a rounded portion of a piece of furniture.

18. The device of claim 1, wherein the vibration device is battery-operated.

19. A portable vibration device for attaching to a structure or person, comprising:
a) a vibration-producing component including a first recess;
b) a clamping component for attaching said vibration-producing component to a structure or person to thereby transmit vibrations thereto;
c) said clamping component including an arm slidable in said first recess relative to said vibration-producing component for adjusting a distance between said vibration-producing component and a structure or person when the vibration devices is in use; and
d) said vibration-producing component including a second recess for storing said arm when the vibration device is not in use thereby providing a compact unit.

20. The device of claim 19, wherein:
a) said arm includes first and second end portions;
b) said first end portion extends into said first recess;
c) said clamping component includes a jaw member for securing the vibration device to a structure or person; and
d) said jaw member extends generally transversely to said arm.

21. The device of claim 20, further comprising:
a) a cam lever for locking said arm relative to said vibration-producing component thereby clamping the vibration device to a structure or person.

22. The device of claim 21, wherein:
a) said cam lever includes a locking cam extending into said first recess to lockingly engage said arm.

23. The device of claim 21, wherein:
a) one of said jaw member and said vibration-producing component includes a tab, and the other of said jaw member and said vibration-producing component includes a third recess for receiving said tab.

24. The device of claim 23, wherein:
a) said vibration-producing component includes front, rear, top, and bottom;
b) said tab is positioned about the bottom of said vibration-producing component and said jaw member includes said third recess;
c) said second recess extends generally vertically on the rear of said vibration-producing component; and
d) wherein said arm can be removed from said first recess to be positioned in said second recess such that said tab is received in said third recess when the vibration device is not in use.

25. The device of claim 20, wherein:
a) said jaw member includes a cut-out for securing to a rounded portion of a piece of furniture.

26. The device of claim 19, wherein:
a) said first and second recesses extend along generally orthogonal axes.

27. The device of claim 19, wherein the vibrator device is battery-operated.

28. A portable vibration device, comprising:
a) a vibration-producing component including a recess;
b) an attachment component including an arm slidable in said recess;
c) a locking lever for locking said arm relative to said vibration-producing component;
d) said arm including first and second end portions; and
e) said first end portion of said arm for extending into said recess.

29. The device of claim 1, further comprising:
a) a cushion member attached to the second end portion of said arm.

30. The device of claim 29, wherein:
a) said cushion member comprises a generally U-shaped member for engaging a body part of a person to thereby transmit vibrations thereto.

31. The device of claim 1, further comprising:
a) a contoured member attached to the second end portion of said arm to be grasped by a person to thereby transmit vibrations to a person's hand or body.

32. A portable vibration device for attaching to a bed frame, comprising:
a) a vibration-producing component including a recess;
b) an attachment component;
c) said attachment component including a first portion slidable in said recess and a second portion to be attached to a section of a bed frame; and
d) a locking member for interlocking said attachment component with the section of the bed frame.

33. The device of claim 32, wherein:
a) said recess extends along the length of said vibration-producing component on the rear thereof.

34. The device of claim 32, wherein:
a) said first and second portions of said attachment component provide a clearance therebetween for receiving the section of the bed frame.

35. A portable vibration device for attaching to a pad, comprising:
a) a vibration-producing component including a recess;
b) an attachment component including an arm slidable in said recess;
c) a locking lever for locking said arm relative to said vibration-producing component;
d) said arm including first and second end portions;
e) said first end portion of said arm for extending into said recess;
f) said second portion of said arm being attached to a pad; and
g) whereby the vibration device can be used as a foot massager by placing at least one foot on the pad.

36. A portable agitator for attaching to a container, comprising:
a) a vibration-producing component including a recess;
b) an attachment component;
c) said attachment component including a first portion slidable in said recess and a second portion for engaging a container;
d) a locking member for interlocking said attachment component with the vibration-producing component; and
e) whereby the vibration device can be used to transmit vibrations to a container thereby agitating the material therein.
